(19) United States
(12) Patent Application Publication
(10) Pub. No.: US 2009/0141275 A1
(43) Pub. Date: Jun. 4, 2009

(54) ALIGNMENT INSPECTION METHOD AND ALIGNMENT INSPECTION APPARATUS

(75) Inventors: Il-Young HAN, Uiwang-si (KR); Mitsuo Umemoto, Seongnam-si (KR); Ki-Kwon Jeong, Cheonan-si (KR); Young-shin Choi, Cheonan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/327,066

(22) Filed: Dec. 3, 2008

(30) Foreign Application Priority Data
Dec. 3, 2007 (KR) 2007-124328

(51) Int. Cl. G01B 11/00; B32B 37/12

(52) U.S. Cl. 356/400; 156/379

(57) ABSTRACT

A method of inspecting the alignment of a second structure with respect to a first structure, including emitting light from a first plane of a first structure to a second plane of a second structure in a first direction perpendicular to the first plane of the first structure, the first plane and the second plane facing each other. The incident light can be reflected from the second plane toward the first plane in a second direction parallel with the first direction. The position of the reflected light can be detected to inspect the alignment of the second structure with respect to the first structure.

### CROSS-REFERENCE TO RELATED APPLICATIONS

This application claims priority under 35 U.S.C. §119 to Korean Patent Application No. 2007-124328, filed on Dec. 3, 2007 in the Korean Intellectual Property Office (KIPO), the contents of which are herein incorporated by reference in its entirety.

### BACKGROUND OF THE INVENTION

1. Field of the Invention

The present general inventive concept relates to an alignment inspection method and an alignment inspection apparatus, and more particularly, to a method of inspecting the alignment of a mechanical structure to adhere surfaces of two bonded objects to each other, and an alignment inspection apparatus to perform the same.

2. Description of the Related Art

Nowadays, semiconductor packages are becoming miniaturized, slimmer and lightweight according to the miniaturization trend of various electronic products using semiconductor devices. Conventionally, a single chip package where only one semiconductor chip is mounted in one semiconductor package is employed. Recently, however, a multi-chip package where various semiconductor chips are mounted in one semiconductor package is being widely employed.

Accordingly, in a manufacturing process of the multi-chip package, one matter of concern may be how many semiconductor chips capable of performing different functions are mounted in one standardized semiconductor package. Thus, a chip stack package where a plurality of semiconductor chips are vertically stacked to form a unit semiconductor package has been developed.

A die bonding apparatus may be used to bond the semiconductor chip to a substrate such as a lead frame or another semiconductor chip. For example, a flip-chip bonding apparatus may bond the semiconductor chip to a bonded object using heat, pressure or ultrasonic vibration.

Generally, the flip-chip bonding apparatus includes a bonding stage where a first bonded object such as the substrate or the semiconductor chip is supported and a bonding head arranged over the bonding stage to grip and bond a second bonded object such as the semiconductor chip to the first object. The bonding head includes a horizontal driving portion to move the second bonded object to an adhesion position on the gripped first bonded object, and a vertical driving portion to lower the second bonded object to make contact with the first bonded object, resulting in a large-sized and heavy bonding head.

Thus, a large driving load is required to drive the bonding head. In addition, the bonding head and the bonding stage operate at a temperature higher than a normal temperature, and a relatively high pressure is continuously maintained between the bonding stage and the bonding head.

However, to bond the second bonded object to the first bonded object, the bonding head is required to be aligned to the bonding stage with a predetermined distance between the first and second bonded objects. For example, the spatial position of the bonding head may be set with respect to the bonding stage such that the semiconductor chip is bonded to be parallel with the substrate or another semiconductor chip within a limited tolerance of several micrometers.

If the central axis of the bonding head is deviated with respect to the bonding stage or the bonding head is inclined with respect to the bonding stage due to the heat or pressure, the semiconductor chip with tilted arrangement is bonded to thereby cause an alignment error. Accordingly, an apparatus to inspect the alignment of the bonding head with respect to the bonding stage may be required in order to detect the error.

However, a conventional alignment inspection apparatus needs a laser generator, a beam splitter and complicated optical devices. Further, these devices may require a relatively large accommodation space therefor, and thus these devices may be not acceptable for a small-sized machine.

### SUMMARY OF THE INVENTION

Example embodiments of the present general inventive concept can provide an alignment inspection apparatus having a relatively small-sized and simple structure.

Example embodiments can also provide a bonding apparatus for a semiconductor chip having the same.

Example embodiments can also provide a method of inspecting the alignment of a mechanical structure to adhere surfaces of two bonded objects to each other using the alignment inspection apparatus.

Example embodiments can also provide a method of inspecting the alignment of a bonding apparatus for a semiconductor chip using the alignment inspection apparatus.

Additional example embodiments of the present general inventive concept will be set forth in part in the description which follows and, in part, will be obvious from the description, or may be learned by practice of the general inventive concept.

According to some example embodiments, there is provided a method of inspecting the alignment of a second structure with respect to a first structure, including emitting light from a first plane of a first structure to a second plane of a second structure in a first direction perpendicular to the first plane of the first structure, the first plane and the second plane facing each other. The incident light can be reflected from the second plane toward the first plane in a second direction parallel with the first direction. The position of the reflected light can be detected to inspect the alignment of the second structure with respect to the first structure.

In an example embodiment, the operation of detecting the position of the reflected light may include detecting a deviation of the central axis of the second structure with respect to the first direction or an inclination of the second structure with respect to a third direction perpendicular to the first direction in a state in which the second structure stands still with respect to the first structure.

In an example embodiment, the operation of detecting the position of the reflected light may also include detecting an inclination of the central axis of the second structure with respect to the first direction while the second structure is moved toward the first structure.

In an example embodiment, the operation of detecting the position of the reflected light may also include detecting the reflected light on the first plane of the first structure where the light is irradiated toward the second structure.

In an example embodiment, the operation of reflecting the incident light in the second direction parallel with the first direction may include reflecting the incident light using at least two reflection mirrors. Each of the reflection mirrors may have an inclination of 45°.

In another example embodiment, the operation of reflecting the incident light in the second direction parallel with the first direction may also include firstly reflecting the incident light, transmitting a portion of the firstly reflected light and reflecting another portion of the firstly reflected light in a direction perpendicular to a direction of the transmitted light, secondly reflecting the transmitted light in a direction parallel with the first direction, and thirdly reflecting the reflected light in a direction parallel with the first direction.

In still another example embodiment, the operation of irradiating the light to the second plane of the second structure may include irradiating first light and second light to the second plane of the second structure, and the operation of reflecting the incident light in the second direction parallel with the first direction may include firstly reflecting the first light and the second light in directions perpendicular to each other, respectively, and secondly reflecting the firstly reflected first light and the firstly reflected second light in directions parallel with the first direction, respectively.

In still another example embodiment, the alignment of the second structure with respect to the first structure may be determined by an inclination angle of the second structure with respect to an x-axis of the first structure and an inclination angle of the second structure with respect to a y-axis of the first structure.

According to another example embodiment, there is provided a method of inspecting the alignment of a structure, including disposing a reference structure between a first structure and a second structure, irradiating first light from a first plane of the first structure to a second plane of the reference structure in a first direction perpendicular to the first plane of the first structure, the first plane and the second plane facing each other, and irradiating second light from a third plane of the second structure to a fourth plane of the reference structure in a second direction perpendicular to the third plane of the second structure, the third plane and the fourth plane facing each other. The first incident light can be reflected from the second plane toward the first plane in a third direction parallel with the first direction. The second incident light can be reflected from the fourth plane toward the third plane in a fourth direction parallel with the second direction. The position of the first reflected light can be detected to inspect the alignment of the first structure with respect to the reference structure. The position of the second reflected light can be detected to inspect the alignment of the second structure with respect to the reference structure.

According to still another example embodiment, there is provided a method of inspecting the alignment of a bonding apparatus for a semiconductor chip, including arranging a bonding head to adhere a semiconductor chip to a bonded object over a bonding stage where the bonded object is disposed thereon, and irradiating light from a first plane of the bonding stage to a second plane of the bonding head in a first direction perpendicular to the first plane of the bonding stage, the first plane and the second plane facing each other. The incident light can be reflected from the second plane toward the first plane in a second direction parallel with the first direction. The position of the reflected light can be detected to inspect the alignment of the bonding head with respect to the bonding stage.

According to some example embodiments, there is provided an alignment inspection apparatus including a reflection module and a sensing module. The reflection module can be installed in a second structure that is spaced apart from a first structure, the reflection module reflecting incident light in a direction parallel with the incident direction of the incident light. The sensing module can be installed in the first structure, the sensing module including a light emitter to irradiate the light to the reflection module and a light receiver to detect the position of the reflected light from the reflection module to inspect the alignment of the second structure with respect to the first structure.

In an example embodiment, the reflection module may include at least two reflection mirrors. Each of the reflection mirrors may have an inclination of 45°.

In another example embodiment, the reflection mirrors may be disposed opposite to each other on the second structure, the first reflection mirror having a first inclination angle with respect to the first structure and the second reflection mirror having a second inclination angle with respect to the first structure, and wherein the sum of the first and second inclination angles is 90°.

In another example embodiment, the reflection module may include a first reflection mirror to reflect the incident light from the light emitter, a half mirror to transmit a portion of the reflected light from the first reflection mirror and to reflect another portion of the reflected light from the first reflection mirror in a direction perpendicular to a direction of the transmitted light, a second reflection mirror to reflect the transmitted light from the half mirror, and a third reflection mirror to reflect the reflected light from the half mirror.

In still another example embodiment, the reflection module may include two pairs of four reflection mirrors that are disposed to be perpendicular to each other, and the sensing module may include two pairs of the light emitters and the light receivers that are disposed to be perpendicular to each other according to the reflection mirrors.

According to another example embodiment, there is provided an alignment inspection apparatus including a reflection module, a first sensing module and a second sensing module. The reflection module can be installed on a reference structure that is disposed between and a first structure and a second structure to reflect incident light in a direction parallel with the incident direction of the incident light. The first sensing module can be installed on the first structure, the first sensing module including a first light emitter to irradiate first light to the reflection module and a first light receiver to detect the position of the reflected light from the reflection module to inspect the alignment of the first structure with respect to the reference structure. The second sensing module can be installed on the second structure, the second sensing module including a second light emitter to irradiate second light to the reflection module and a second light receiver to detect the position of the reflected light form the reflection module to inspect the alignment of the second structure with respect to the reference structure.

In another example embodiment, the reflection module may include at least two first reflection mirrors to reflect the incident first light from the first structure and at least two second reflection mirrors to reflect the incident second light from the second structure.

In another example embodiment, the reflection module may include two pairs of four first reflection mirrors that are disposed to be perpendicular to each other and face toward the first structure and two pairs of four second reflection mirrors that are disposed to be perpendicular to each other and face toward the second structure, the first sensing module may include two pairs of the first light emitters and the first light receivers that are disposed to be perpendicular to each other according to the first reflection mirrors, and the second sensing module may include two pairs of the second light emitters and the second light receivers that are disposed to be perpendicular to each other according to the second reflection mirrors.

According to still another example embodiment, there is provided a bonding apparatus for a semiconductor chip, including a bonding stage to support a bonded object, a bonding head spaced apart over the bonding stage to adhere a semiconductor chip to the bonded object, a reflection module installed in the bonding head to reflect incident light in a direction parallel with the incident direction of the incident light, and a sensing module installed in the bonding stage, the sensing module including a light emitter to irradiate the light to the reflection module and a light receiver to detect the position of the reflected light from the reflection module to inspect the alignment of the bonding head with respect to the bonding stage.

According to still yet another example embodiment, there is provided a bonding apparatus for a semiconductor chip, including a bonding stage to support a bonded object, a bonding head spaced apart over the bonding stage to adhere a semiconductor chip to the bonded object, a reference structure disposed between the bonding stage and the bonding head, a reflection module installed on the reference structure to reflect incident light in a direction parallel with the incident direction of the incident light, a first sensing module installed on the bonding stage, the first sensing module including a first light emitter to irradiate first light to the reflection module and a first light receiver to detect the position of the reflected light from the reflection module to inspect the alignment of the bonding stage with respect to the reference structure, and a second sensing module installed on the bonding head, the second sensing module including a second light emitter to irradiate second light to the reflection module and a second light receiver to detect the position of the reflected light from the reflection module to inspect the alignment of the bonding head with respect to the reference structure.

According to some example embodiments, the alignment inspection apparatus can include a reflection module and a sensing module. The reflection module can be installed on a second structure that is spaced apart from a first structure to reflect incident light in a direction parallel with the incident direction of the incident light. The sensing module can include a light emitter installed on the first structure to irradiate the light to the reflection module and a light receiver installed in the first structure to detect the position of the reflected light from the reflection module.

Another example embodiment provides a reflection module usable with an alignment inspection apparatus to inspect the alignment between a first structure and a second structure, the reflection module including a first reflecting portion including at least two reflection mirrors disposed opposite to each other on a first side of a reference plate to firstly reflect first light incident from the first structure, and a second reflecting portion including at least two reflection mirrors disposed opposite to each other on a second side of the reference plate to secondly reflect second light incident from the second structure, where the firstly and secondly reflected light is directed back to the first and second structures in a direction parallel to an incident direction of the first and second light, respectively, and the location of the firstly and secondly reflected light incident on the first and second structures is used to determine the alignment of the first and second structures with respect to the reference plate, respectively.

In another example embodiment, the location of the firstly and secondly reflected light may be used to determine an inclination angle of a first axis of the first and second structures with respect to a first axis of the reference plate while the first structure is moved toward or away from the second structure along the first axis, the first axis being substantially parallel to the incident direction of the first and second light.

In another example embodiment, the location of the firstly and secondly reflected light may be used to determine an inclination angle of second and third axes of the first and second structures with respect to second and third axes of the reference plate while the first structure stands still with respect to the second structure, the second and third axes being substantially perpendicular to the incident direction of the first and second light.

Accordingly, the alignment inspection apparatus can have a relatively simple structure to inspect the alignment states of the first structure and the second structure. Additionally, the alignment inspection apparatus may be installed in a bonding apparatus for a semiconductor chip to inspect the alignment of a semiconductor chip to be adhered to a substrate or another semiconductor chip in an adhesion region thereof.

### BRIEF DESCRIPTION OF THE DRAWINGS

Example embodiments of the present general inventive concept will be more clearly understood from the following detailed description taken in conjunction with the accompanying drawings.

FIG. 1 is a view illustrating a bonding apparatus for a semiconductor chip including an alignment inspection apparatus in accordance with example embodiments of the present general inventive concept.

FIG. 2A is a perspective view illustrating the alignment inspection apparatus of FIG. 1.

FIG. 2B is a front view illustrating the alignment inspection apparatus of FIG. 1.

FIG. 2C is a side view illustrating the alignment inspection apparatus of FIG. 1.

FIG. 3 is a perspective view illustrating the alignment inspection apparatus with the bonding head of FIG. 1 tilted.

FIG. 4 is a view illustrating an inclination of a reflection module of FIG. 3.

FIGS. 5 to 8 are side views illustrating a method of inspecting the alignment of the bonding apparatus for a semiconductor chip using the alignment inspection apparatus of FIG. 1.

FIG. 9A is a perspective view illustrating a sensing module of an alignment inspection apparatus in accordance with another example embodiment.

FIG. 9B is a plan view illustrating a reflection module of an alignment inspection apparatus in accordance with another example embodiment.

FIG. 10A is a perspective view illustrating a sensing module of an alignment inspection apparatus in accordance with still another example embodiment.

FIG. 10B is a plan view illustrating a reflection module of an alignment inspection apparatus in accordance with still another example embodiment.

FIG. 11 is a front view illustrating an alignment inspection apparatus in accordance with still yet another example embodiment.

FIG. 12 is a perspective view illustrating the reflection module of FIG. 11.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The example embodiments are described below in order to explain the present general inventive concept by referring to the figures. The present general inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are merely used to distinguish one element, component, region, layer or section from another region, layer or section. Thus, a first element, component, region, layer or section discussed below could be termed a second element, component, region, layer or section without departing from the broader teachings, principles, and spirit of the present general inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the meaning as commonly understood by one of ordinary skill in the art to which the present general inventive concept pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

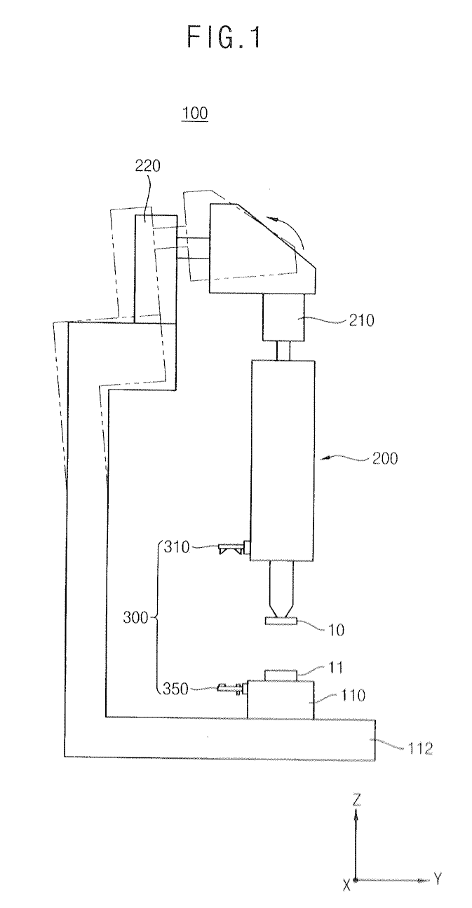

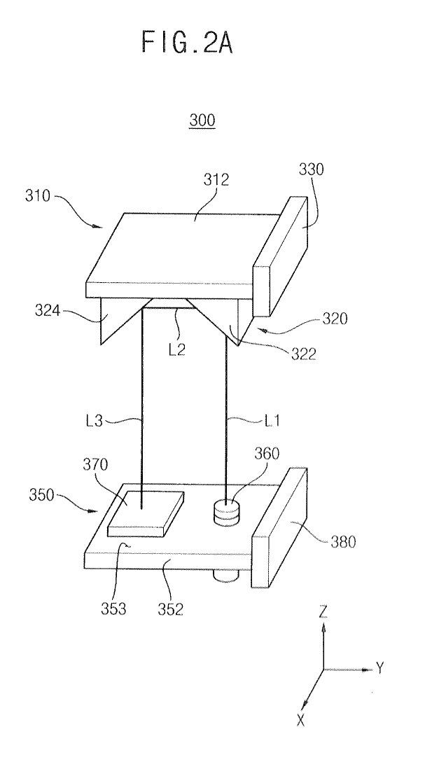

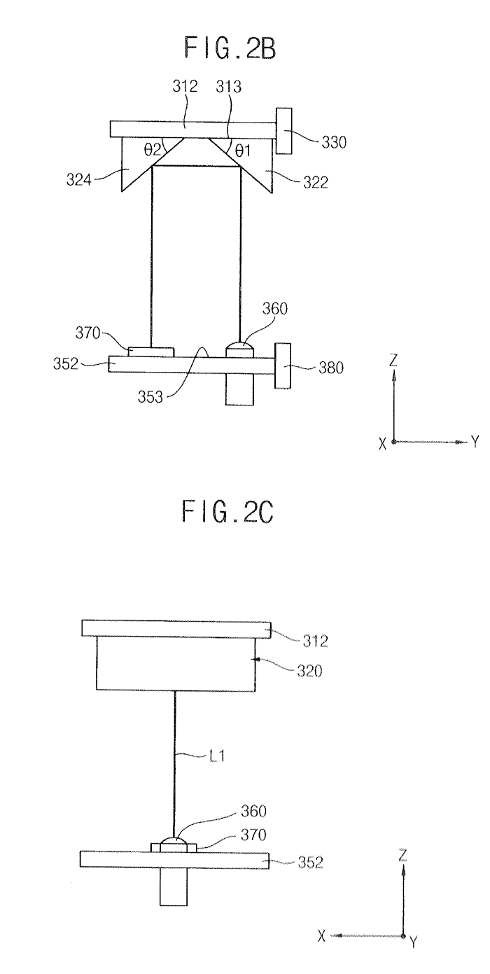

FIG. 1 is a view illustrating a bonding apparatus for a semiconductor chip including an alignment inspection apparatus in accordance with example embodiments of the present general inventive concept. FIG. 2A is a perspective view illustrating the alignment inspection apparatus of FIG. 1. FIG. 2B is a front view illustrating the alignment inspection apparatus of FIG. 1. FIG. 2C is a side view illustrating the alignment inspection apparatus of FIG. 1. Although a bonding apparatus for a semiconductor chip is illustrated in FIGS. 1 to 2C, it will be understood that example embodiments may be employed in a mechanical mechanism including first and second structures that are spaced apart from each other and movable with respect to each other.

Referring to FIGS. 1 to 2C, a bonding apparatus for a semiconductor chip 100 according to example embodiments includes a bonding stage 110, a bonding head 200 that is spaced apart from the bonding stage 110 and arranged to be movable upward and downward over the bonding stage 110, and an alignment inspection apparatus 300 to inspect the alignment of the bonding head 200 with respect to the bonding stage 110.

A second bonded object 11 such as a substrate and a semiconductor chip can be disposed on the bonding stage 110. A first bonded object 10 such as a semiconductor chip can be gripped and adhered to the second bonded object 11 by the bonding head 200. The bonding stage 110 may be installed in a lower portion of a frame 112 of the bonding apparatus for a semiconductor chip 100 and the bonding head 200 may be installed in an upper portion of the frame 112. The bonding head 200 may include a horizontal driving portion 220 to move the gripped first bonded object 10 over the second bonded object 11 that is disposed on the bonding stage 110 and a vertical driving portion 210 to lower the first bonded object 10 to contact the second bonded object 11.

Here, the bonding stage 110 may correspond to a first structure and the bonding head 200 may correspond to a second structure. Each of the first and second bonded objects 10 and 11 may have a plate shape having a respective one of planes that are bonded to each other.

The alignment inspection apparatus 300 according to example embodiments include a reflection module 310 and a sensing module 350. For example, the reflection module 310 may be installed in the bonding head 200 and the sensing module 350 may be installed in the bonding stage 110. Alternatively, the reflection module 310 may be installed in the bonding stage 110 and the sensing module 350 may be installed in the bonding head 200.

The reflection module 310 may include a first plate 312 that is installed in the bonding head 200 and a reflecting portion 320 having at least two reflection mirrors 322 and 324 that are disposed in the first plate 312. For example, the first plate 312 may be installed in the bonding head 200 by a first coupling member 330.

The sensing module 350 may include a second plate 352, and a light emitter 360 and a light receiver 370 that are disposed in the second plate 352. For example, the second plate 352 may be installed in the bonding stage 110 by a second coupling member 380.

In an example embodiment, the reflection mirrors 322 and 324 of the reflection module 310 may be disposed on a first plane 313 of the first plate 312 substantially parallel with the plane where the first bonded object 10 is adhered. The light emitter 360 and the light receiver 370 of the sensing module 350 may be disposed on a second plane 353 of the second plate 352 substantially parallel with the plane where the second bonded object 11 is adhered.

The light emitter 360 of the sensing module 350 can include a light source that generates light. For example, first light L1 generated from the light emitter 360 can be incident to the reflection module 310 along a first direction substantially perpendicular to the second plane 353.

In an example embodiment, the reflection module 310 may include a first reflection mirror 322 and a second reflection mirror 324. The first and second mirrors 322 and 324 may be opposite to each other. The first mirror 322 may have an inclination of θ1 with respect to the first plane 313 of the first plate 312 and the second mirror 324 may have an inclination of θ2 with respect to the first plane 313 of the first plate 312. As such, the sum of θ1 and θ2 may be 90° and, for example, θ1 and θ2 may be 45°, respectively.

The first light L1 that is incident along the first direction from the light emitter 360 of the sensing module 350 may be incident to the first reflection mirror 322 of the reflection module 310. The first reflection mirror 322 firstly reflects the first light L1 that is incident along the first direction from the light emitter 360 of the sensing module 350. The second reflection mirror 324 secondly reflects second light L2 reflected from the first reflection mirror 322 in a second direction. Third light L3 that is reflected from the second reflection mirror 324 is incident to the sensing module 350 again, and then, the light receiver 370 of the sensing module 350 detects the position of the third light L3 that is reflected from the reflection module 310. Here, the first direction of the first light L1 is parallel with the second direction of the third light L3.

Accordingly, the light emitter 360 of the sensing module 350 can irradiate light to the reflection module 310 in the first direction substantially perpendicular to the second plane 353 of the second plate 352, and then, the reflection module 310 can reflect the incident light in the second direction substantially parallel with the first direction. The light receiver 370 of the sensing module 350 can detect the position of the reflected light that is incident in the second direction.

On the other hand, the bonding apparatus for a semiconductor chip 100 may operate at a temperature higher than a normal temperature, and a relatively high pressure may be continuously maintained between the bonding stage 110 and the bonding head 200. Thus, the bonding head 200 may operate in a tilted state with respect to the bonding stage 110.

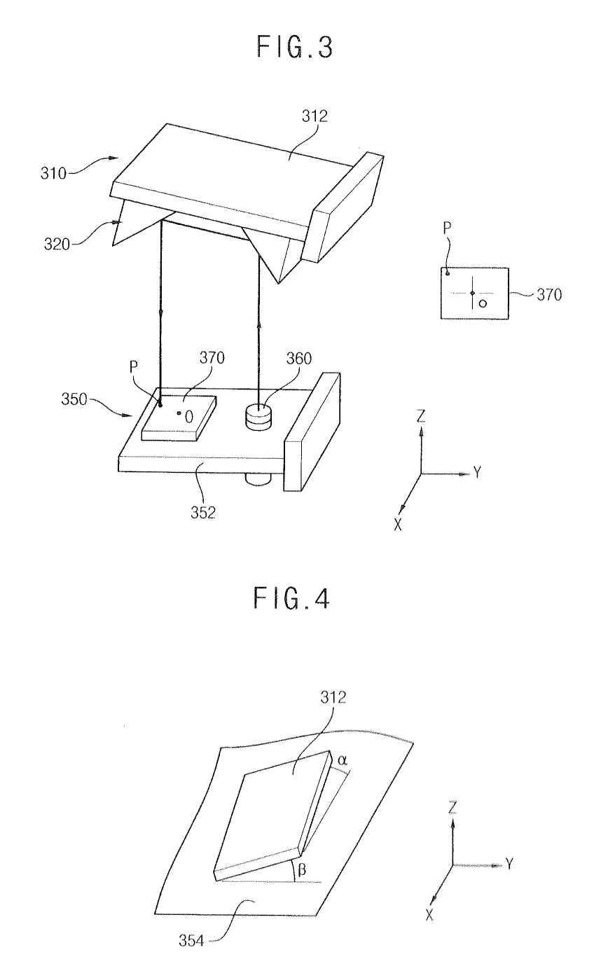

FIG. 3 is a perspective view illustrating the alignment inspection apparatus with the bonding head of FIG. 1 tilted. FIG. 4 is a view illustrating an inclination of a reflection module in FIG. 3. Here, FIG. 3 presents a tilted state of the bonding head 200 with respect to x- and y-axes of the bonding stage 110.

Referring to FIGS. 3 and 4, when the bonding head 200 is aligned accurately with respect to the bonding stage 110, the reflected light from the reflection module 310 can be detected at a center O of the light receiver 370.

When the bonding head 200 is tilted with respect to the bonding stage 110, the first plate 312 of the reflection module 310 that is installed in the bonding head 200 is also tilted at an inclination substantially the same as that of the bonding head 200 with respect to the bonding stage 110. As such, once the light emitter 360 of the sensing module 350 irradiates light to the reflection module 310 in the first direction, the reflected light from the reflection module 310 can be incident to the light receiver 370 in the second direction substantially parallel with the first direction. The incident light to the light receiver 370 can be detected at a point P by the inclination of the first plate 312.

Accordingly, the alignment inspection apparatus 300 according to an example embodiment may measure the inclination of the first plate 312 with respect to the xy-plane 354 of the second plate 352. The inclination of the first plate 312 may be determined by an inclination α with respect to the x-axis and an inclination β with respect to the y-axis.

Methods of inspecting the alignment of a mechanical structure using an alignment inspection apparatus in accordance with example embodiments of the present general inventive concept will be explained in detail with reference to the accompanying drawings.

Referring again to FIG. 1, first, the bonding head 200 can be positioned over the bonding stage 110. Here, the reflection module 310 is installed at a side of the bonding head 200 and the sensing module 350 is installed at a side of the bonding stage 110.

Light from the light emitter of the sensing module 350 can be incident to the reflection module of the bonding head 200 in the first direction (z-axis direction) perpendicular to the bonding stage 110. Then, the incident light can be reflected in the second direction parallel with the first direction by the reflection mirrors of the reflection module. The reflected light can be incident to the light receiver of the sensing module 350, and the position of the reflected light can be detected by the light receiver to inspect the alignment of the bonding head 200 with respect to the bonding stage 110.

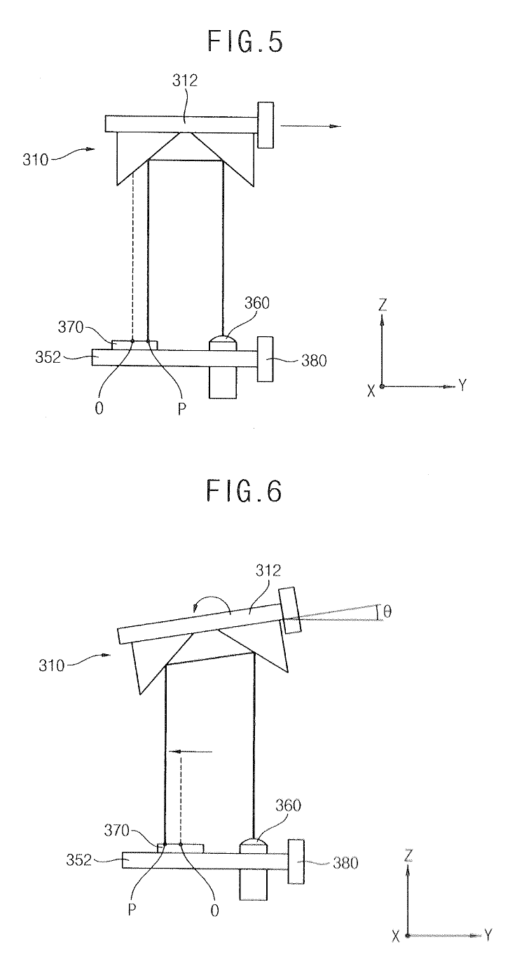

FIGS. 5 to 8 are side views illustrating a method of inspecting the alignment of the bonding apparatus for a semiconductor chip using the alignment inspection apparatus of FIG. 1.

Referring to FIG. 5, in a state in which the bonding head 200 is spaced apart from the bonding stage 110 by a predetermined distance, a deviation of the central axis of the bonding head 200 with respect to the bonding stage 110 may be detected.

For example, when the first plate 312 of the reflection module 310 is parallel with the xy-plane of the second plate 352 and the central axis of the bonding head 200 at an adhesion position of the first bonded object is deviated from the central axis of the bonding stage 110 in the y-axis, the detected position P of the light is deviated from the center O of the light receiver 370 in the y-axis direction. Accordingly, in a state in which the bonding head 200 stands still with respect to the bonding stage 110, a deviation of the central axis of the bonding head 200 with respect to the first direction (that is, a direction parallel with the z-axis direction) may be detected.

Referring to FIG. 6, in a state in which the bonding head 200 is spaced apart from the bonding stage 110 by a predetermined distance, an inclination of the bonding head 200 with respect to the bonding stage may be detected.

For example, when the central axis of the bonding head 200 at an adhesion position of the first bonded object is aligned with the central axis of the bonding stage and the first plate 312 is inclined with respect to the y-axis of the xy-plane of the second plate 352, the detected position P of the light is deviated from the center O of the light receiver 370 in the y-axis direction. Accordingly, in a state in which the bonding head 200 stands still with respect to the bonding stage 110, an inclination of the bonding head 200 with respect to the second direction (that is, the y-axis direction) substantially perpendicular to the first direction may be detected.

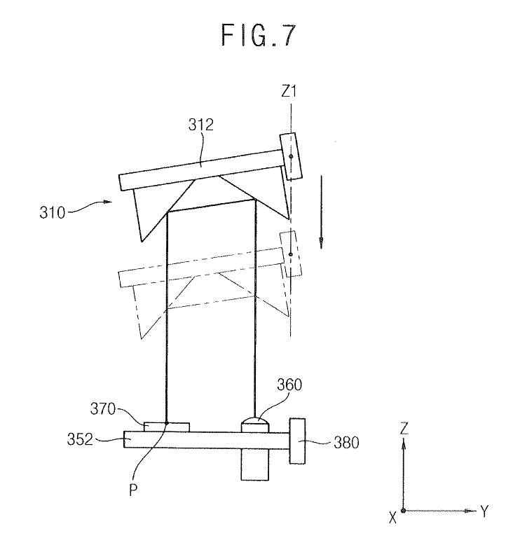

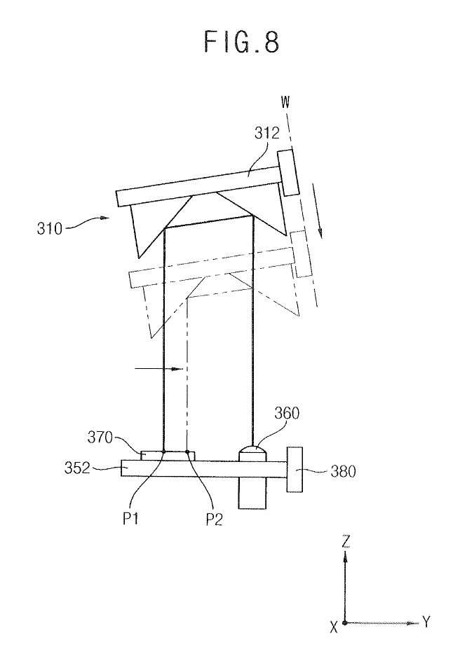

Referring to FIGS. 7 and 8, while the bonding head 200 is moved toward the bonding stage 110, an inclination of the central axis of the bonding head 200 with respect to the bonding stage 110 may be detected.

For example, in a state in which the central axis of the bonding head 200 is aligned with the central axis of the bonding stage 110 and the first plate 312 is inclined at an angle with respect to the y-axis of the xy-plane of the second plate 352, while the bonding head 200 is moved toward the bonding stage 110, an inclination of the central axis of the bonding head 200 with respect to the first direction (that is, a direction parallel with the z-axis direction) may be detected.

In FIG. 7, while moving the bonding head 200 toward the bonding stage 110, the bonding head 200 moves in an axis direction Z1 substantially parallel with the first direction and perpendicular to the xy-plane. In this case, since the detected position P of the light stands still regardless of the movement of the bonding head 200, it may be understood that the central axis of the bonding head 200 is not inclined with respect to the first direction.

In FIG. 8, while moving the bonding head 200 toward the bonding stage 110, the bonding head 200 moves in a direction W inclined with respect to the first direction (that is, a direction inclined with respect to the bonding stage 110). In this case, since the detection position of the light moves from a first position P1 to a second position P2, it may be understood that the central axis of the bonding head 200 with respect to the first direction.

In an example embodiment, the bonding apparatus for a semiconductor chip 100 may further include an alignment correction portion (not illustrated) to correct the alignment of the bonding head 200 with respect to the bonding stage 110. Accordingly, after inspecting the alignment of the bonding head 200 with respect to the bonding stage 110, the bonding head 200 may be corrected.

In addition, while a process to adhere the first and second bonded objects is performed, the alignment of the bonding head 200 with respect to the bonding stage 110 may be inspected using the alignment inspection apparatus 300. If an alignment error of the bonding head 200 exceeds the correctable limit, the bonding process can be discontinued and the bonding apparatus for a semiconductor chip 100 may be repaired or replaced with a new one.

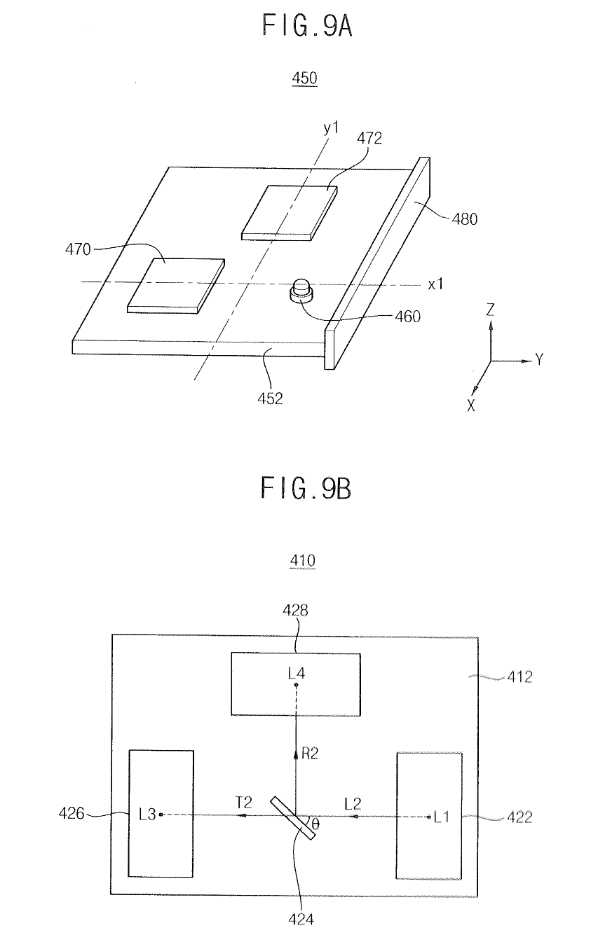

FIG. 9A is a perspective view illustrating a sensing module of an alignment inspection apparatus in accordance with another example embodiment. FIG. 9B is a plan view illustrating a reflection module of an alignment inspection apparatus in accordance with another example embodiment. The alignment inspection apparatus of the present embodiment may include elements substantially the same as those of the apparatus in example embodiments of FIG. 1 except for a reflection module having a half mirror and a relative arrangement of reflection/sensing modules. Thus, any further explanations with respect to the same elements will be omitted.

Referring to FIGS. 9A and 9B, an alignment inspection apparatus according to another example embodiment includes a reflection module 410 and a sensing module 450. The reflection module 410 includes a first reflection mirror 422, a half mirror 424, a second reflection mirror 426 and a third reflection mirror 428 that are disposed on a first plate 412. The sensing module 450 can include a light emitter 460, a first light receiver 470 and a second light receiver 472 that are disposed on a second plate 452 with a second coupling member 480.

The first reflection mirror 422 can reflect light L1 incident from the light emitter 460 firstly. The half mirror 424 transmits a portion of the reflected light L2 from the first reflection mirror 422 and can reflect another portion of the reflected light L2 in a direction substantially perpendicular to the transmitted direction. The second reflection mirror 426 can reflect the transmitted light T2 from the half mirror 424 and the third reflection mirror 428 can reflect the reflected light R2 from the half mirror 424.

In another example embodiment, the first light receiver 470 may be disposed along a direction X1 with respect to the light emitter 460, and the second light receiver 472 may be disposed along a direction Y1 with respect to the light emitter 460. The first light receiver 470 can detect the position of reflected light L3 from the second reflection mirror 426 and the second light receiver 472 can detect the position of reflected light L4 from the third reflection mirror 428.

Accordingly, an alignment inspection apparatus according to another example embodiment may detect a deviation of the central axis of the bonding head 200 or an inclination of the bonding head 200 with respect to the x- and y-axis directions of the bonding stage 110 in a state in which the bonding head 200 stands still with respect to the bonding stage 110. Additionally, an alignment inspection apparatus according to another example embodiment may detect an inclination of the central axis of the bonding head 200 with respect to the z-axis direction of the bonding stage 110 while the bonding head 200 moves toward the bonding stage 110.

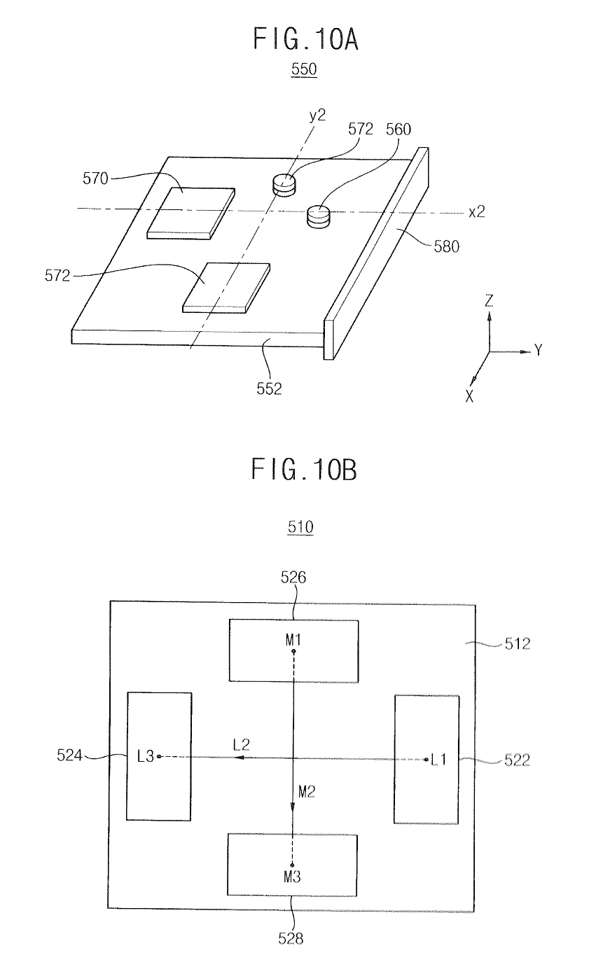

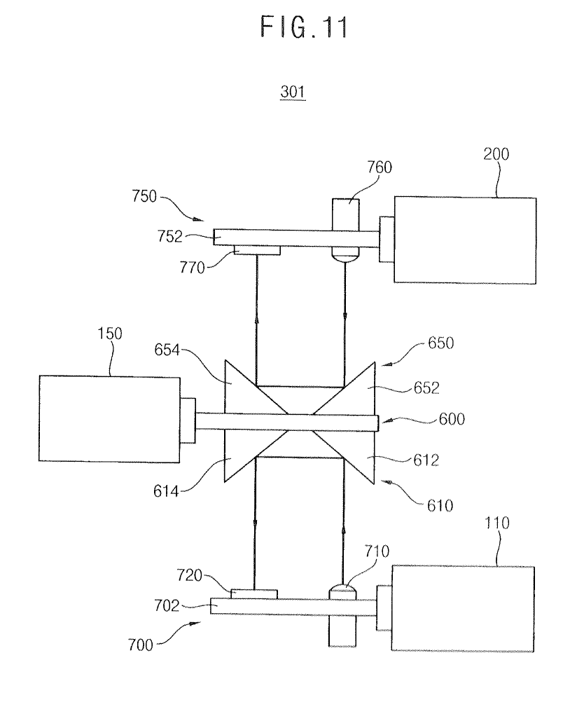

FIG. 10A is a perspective view illustrating a sensing module of an alignment inspection apparatus in accordance with still another example embodiment. FIG. 10B is a plan view illustrating a reflection module of an alignment inspection apparatus in accordance with still another example embodiment. The alignment inspection apparatus of the present embodiment may include elements substantially the same as those of the apparatus in example embodiments of FIG. 1 except for a relative arrangement of reflection/sensing modules. Thus, any further explanations with respect to the same elements will be omitted.

Referring to FIGS. 10A and 10B, an alignment inspection apparatus according to still another example embodiment can include a reflection module 510 and a sensing module 550. The reflection module 510 can include a first reflection mirror 522, a second reflection mirror 524, a third reflection mirror 526 and a fourth reflection mirror 528 that are disposed on a first plate 512. The sensing module 550 can include a first light emitter 560, a first light receiver 570, a second light emitter 562 and a second light receiver 572 that are disposed on a second plate 552 with a second coupling member 580.

The first reflection mirror 522 can reflect incident light L1 from the first light emitter 560. The second reflection mirror 524 can reflect reflected light L2 from the first reflection mirror 522. The third reflection mirror 526 can reflect incident light M1 from the second light emitter 562. The fourth reflection mirror 528 can reflect reflected light M2 from the third reflection mirror 526.

In still another example embodiment, the first light receiver 570 may be disposed along a direction X2 with respect to the first light emitter 560, and the second light receiver 572 may be disposed along a direction Y2 with respect to the second light emitter 562. The first light receiver 570 can detect the position of reflected light L3 from the second reflection mirror 524 and the second light receiver 572 can detect the position of reflected light M3 from the fourth reflection mirror 528.

Accordingly, an alignment inspection apparatus according to still another example embodiment may detect a deviation of the central axis of the bonding head 200 or an inclination of the bonding head 200 with respect to the x- and y-axis directions of the bonding stage 110 in a state in which the bonding head 200 stands still with respect to the bonding stage 110. Additionally, an alignment inspection apparatus according to still another example embodiment may detect the central axis of the bonding head 200 with respect to the z-axis direction of the bonding stage 110 while the bonding head 200 moves toward the bonding stage 110.

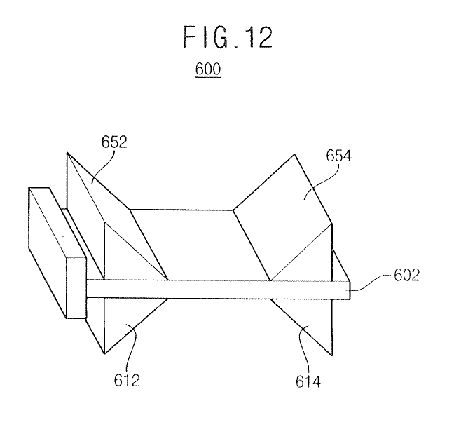

FIG. 11 is a front view illustrating an alignment inspection apparatus in accordance with still yet another example embodiment. FIG. 12 is a perspective view illustrating the reflection module of FIG. 11. The alignment inspection apparatus of the present embodiment may include elements substantially the same as those of the apparatus in example embodiments of FIG. 1 except for a reflection module installed in a reference structure and an additional sensing module installed in a bonding head. Thus, any further explanations with respect to the same elements will be omitted.

Referring to FIGS. 11 and 12, an alignment inspection apparatus 301 according to still yet another example embodiment may include a reflection module 600 installed in a reference structure 150 that is positioned between a bonding stage 110 and a bonding head 200, a first sensing module 700 installed in the bonding stage 110 and a second sensing module 750 installed in the bonding head 200. Here, the bonding head 200 may be spaced apart from the bonding stage 110 by a predetermined distance and may be positioned over the bonding stage 110 to move up and down.

The first sensing module 700 can be installed in the bonding stage 110 including a first light emitter 710 and a first light receiver 720 that are disposed on a first plate 702. Light from the first light emitter 710 is incident to the reflection module 600 and reflected light from the reflection module 600 can be detected in the first light receiver 720.

The second sensing module 750 installed in the bonding head 200 can include a second light emitter 760 and a second light receiver 770 that are disposed on a second plate 752. Light from the second light emitter 760 is incident to the reflection module 600 and reflected light from the reflection module 600 can be detected in the second light receiver 770.

The reflection module 600 may be positioned between the bonding stage 110 and the bonding head 200. The reflection module 600 may reflect incident light in a direction parallel with the incident direction of the incident light.

The reflection module 600 can include a first reflection portion 610 and a second reflection portion 650. The first reflection portion 610 can include at least two reflection mirrors 612 and 614. The second reflection portion 650 can include at least two reflection mirrors 652 and 654. The mirrors 612 and 614 of the first reflection portion 610 may be opposite to the first sensing module 700. The mirrors 652 and 654 of the second reflection portion 650 may be opposite to the second sensing module 750.

Each of the mirrors 612 and 614 of the first reflection portion 610 may have an inclination of a predetermined angle with respect to a reference plate 602. As such, the sum of the angles of the opposite mirrors 612 and 614 of the first reflection portion 610 may be 90°. Each of the mirrors 652 and 654 of the second reflection portion 650 may have an inclination of a predetermined angle with respect to the reference plate 602. As such, the sum of the angles of the opposite mirrors 652 and 654 of the second reflection portion 650 may be 90°.

The first sensing module 700 may inspect the alignment of the bonding stage 110 with respect to the reference structure 150. The second sensing module 750 may inspect the alignment of the bonding head 200 of the reference structure 150.

As mentioned above, an alignment inspection apparatus according to example embodiments may include a reflection module and a sensing module. The reflection module can be installed on a second structure that is spaced apart from a first structure to reflect incident light in a direction parallel with the incident direction of the incident light. The sensing module may include a light emitter installed on the first structure to irradiate the light to the reflection module and a light receiver installed in the first structure to detect the position of the reflected light from the reflection module.

Accordingly, the alignment inspection apparatus can have a relatively simple structure to inspect the alignment states of the first structure and the second structure. Additionally, the alignment inspection apparatus may be installed in a bonding apparatus for a semiconductor chip to inspect the alignment of a semiconductor chip to be adhered to a substrate or another semiconductor chip in an adhesion region thereof.

Although a few example embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of inspecting the alignment of a second structure with respect to a first structure, the method comprising:
irradiating light from a first plane of a first structure to a second plane of a second structure in a first direction perpendicular to the first plane of the first structure, the first plane and the second plane facing each other;
reflecting the incident light from the second plane toward the first plane in a second direction parallel with the first direction; and
detecting the position of the reflected light to inspect the alignment of the second structure with respect to the first structure.

2. The method of claim 1, wherein detecting the position of the reflected light comprises detecting a deviation of the central axis of the second structure with respect to the first direction or an inclination of the second structure with respect to a third direction perpendicular to the first direction in a state in which the second structure stands still with respect to the first structure.

3. The method of claim 1, wherein detecting the position of the reflected light comprises detecting an inclination of the central axis of the second structure with respect to the first direction while the second structure is moved toward the first structure.

4. The method of claim 1, wherein detecting the position of the reflected light comprises detecting the reflected light on the first plane of the first structure where the light is irradiated toward the second structure.

5. The method of claim 1, wherein reflecting the incident light in the second direction parallel with the first direction comprises reflecting the incident light using at least two reflection mirrors.

6. The method of claim 5, wherein each of the reflection mirrors has an inclination of 45°.

7. The method of claim 1, wherein reflecting the incident light in the second direction parallel with the first direction comprises:
firstly reflecting the incident light;
transmitting a portion of the firstly reflected light and reflecting another portion of the firstly reflected light in a direction perpendicular to a direction of the transmitted light;
secondly reflecting the transmitted light in a direction parallel with the first direction; and
thirdly reflecting the reflected light in a direction parallel with the first direction.

8. The method of claim 1, wherein irradiating the light to the second plane of the second structure comprises irradiating first light and second light to the second plane of the second structure, and
reflecting the incident light in the second direction parallel with the first direction comprises:
firstly reflecting the first light and the second light in directions perpendicular to each other, respectively; and
secondly reflecting the firstly reflected first light and the firstly reflected second light in directions parallel with the first direction, respectively.

9. The method of claim 1, wherein the alignment of the second structure with respect to the first structure is determined by an inclination angle of the second structure with respect to an x-axis of the first structure and an inclination angle of the second structure with respect to a y-axis of the first structure.

10. A method of inspecting the alignment of a structure, the method comprising:
disposing a reference structure between a first structure and a second structure;
irradiating first light from a first plane of the first structure to a second plane of the reference structure in a first direction perpendicular to the first plane of the first structure, the first plane and the second plane facing each other;
irradiating second light from a third plane of the second structure to a fourth plane of the reference structure in a second direction perpendicular to the third plane of the second structure, the third plane and the fourth plane facing each other;
reflecting the first incident light from the second plane toward the first plane in a third direction parallel with the first direction;
reflecting the second incident light from the fourth plane toward the third plane in a fourth direction parallel with the second direction;
detecting the position of the first reflected light to inspect the alignment of the first structure with respect to the reference structure; and
detecting the position of the second reflected light to inspect the alignment of the second structure with respect to the reference structure.

11. A method of inspecting the alignment of a bonding apparatus for a semiconductor chip, the method comprising:
arranging a bonding head to adhere a semiconductor chip to a bonded object over a bonding stage where the bonding object is disposed thereon;
irradiating light from a first plane of the bonding stage to a second plane of the bonding head in a first direction perpendicular to the first plane of the bonding stage, the first plane and the second plane facing each other;
reflecting the incident light from the second plane toward the first plane in a second direction parallel with the first direction; and
detecting the position of the reflected light to inspect the alignment of the bonding head with respect to the bonding stage.

12. An alignment inspection apparatus, comprising:
a reflection module installed in a second structure that is spaced apart from a first structure, the reflection module reflecting incident light in a direction parallel with the incident direction of the incident light; and
a sensing module installed in the first structure, the sensing module including a light emitter to irradiate the light to the reflection module and a light receiver to detect the position of the reflected light from the reflection module to inspect the alignment of the second structure with respect to the first structure.

13. The alignment inspection apparatus of claim 12, wherein the reflection module comprises at least two reflection mirrors.

14. The alignment inspection apparatus of claim 13, wherein each of the reflection mirrors has an inclination of 45°.

15. The alignment inspection apparatus of claim 13, wherein the reflection mirrors are disposed opposite to each other on the second structure, the first reflection mirror having a first inclination angle with respect to the first structure and the second reflection mirror having a second inclination angle with respect to the first structure, and wherein the sum of the first and second inclination angles is 90°.

16. The alignment inspection apparatus of claim 12, wherein the reflection module comprises:
a first reflection mirror to reflect the incident light from the light emitter;
a half mirror to transmit a portion of the reflected light from the first reflection mirror and to reflect another portion of the reflected light from the first reflection mirror in a direction perpendicular to a direction of the transmitted light;
a second reflection mirror to reflect the transmitted light from the half mirror; and
a third reflection mirror to reflect the reflected light from the half mirror.

17. The alignment inspection apparatus of claim 12, wherein the reflection module comprises two pairs of four reflection mirrors that are disposed to be perpendicular to each other, and the sensing module comprises two pairs of the light emitters and the light receivers that are disposed to be perpendicular to each other according to the reflection mirrors.

18. An alignment inspection apparatus, comprising:
a reflection module installed on a reference structure that is disposed between and a first structure and a second structure to reflect incident light in a direction parallel with the incident direction of the incident light;
a first sensing module installed on the first structure, the first sensing module including a first light emitter to irradiate first light to the reflection module and a first light receiver to detect the position of the reflected light from the reflection module to inspect the alignment of the first structure with respect to the reference structure; and
a second sensing module installed on the second structure, the second sensing module including a second light emitter to irradiate second light to the reflection module and a second light receiver to detect the position of the reflected light from the reflection module to inspect the alignment of the second structure with respect to the reference structure.

19. The alignment inspection apparatus of claim 18, wherein the reflection module comprises:
at least two first reflection mirrors to reflect the incident first light from the first structure; and
at least two second reflection mirrors to reflect the incident second light from the second structure.

20. The alignment inspection apparatus of claim 18, wherein the reflection module comprises two pairs of four first reflection mirrors that are disposed to be perpendicular to each other and face toward the first structure and two pairs of four second reflection mirrors that are disposed to be perpendicular to each other and face toward the second structure, the first sensing module comprises two pairs of the first light emitters and the first light receivers that are disposed to be perpendicular to each other according to the first reflection mirrors, and the second sensing module comprises two pairs of the second light emitters and the second light receivers that are disposed to be perpendicular to each other according to the second reflection mirrors.

21. A bonding apparatus for a semiconductor chip, comprising:
a bonding stage supporting a bonded object;
a bonding head spaced apart over the bonding stage to adhere a semiconductor chip to the bonded object;
a reflection module installed on the bonding head to reflect incident light in a direction parallel with the incident direction of the incident light; and
a sensing module installed on the bonding stage, the sensing module including a light emitter to irradiate the light to the reflection module and a light receiver to detect the position of the reflected light from the reflection module to inspect the alignment of the bonding head with respect to the bonding stage.

22. A bonding apparatus for a semiconductor chip, comprising:
a bonding stage to support a bonded object;
a bonding head spaced apart over the bonding stage to adhere a semiconductor chip to the bonded object;
a reference structure disposed between the bonding stage and the bonding head;
a reflection module installed on the reference structure to reflect incident light in a direction parallel with the incident direction of the incident light;
a first sensing module installed on the bonding stage, the first sensing module including a first light emitter to irradiate first light to the reflection module and a first light receiver to detect the position of the reflected light from the reflection module to inspect the alignment of the bonding stage with respect to the reference structure; and
a second sensing module installed on the bonding head, the second sensing module including a second light emitter to irradiate second light to the reflection module and a second light receiver to detect the position of the reflected light from the reflection module to inspect the alignment of the bonding head with respect to the reference structure.

23. A reflection module usable with an alignment inspection apparatus to inspect the alignment between a first structure and a second structure, the reflection module comprising:
a first reflecting portion including at least two reflection mirrors disposed opposite to each other on a first side of a reference plate to firstly reflect first light incident from the first structure; and
a second reflecting portion including at least two reflection mirrors disposed opposite to each other on a second side of the reference plate to secondly reflect second light incident from the second structure,
where the firstly and secondly reflected light is directed back to the first and second structures in a direction parallel to an incident direction of the first and second light, respectively, and
the location of the firstly and secondly reflected light incident on the first and second structures is used to determine the alignment of the first and second structures with respect to the reference plate, respectively.

24. The reflection module of claim 23, wherein the location of the firstly and secondly reflected light is used to determine an inclination angle of a first axis of the first and second structures with respect to a first axis of the reference plate while the first structure is moved toward or away from the second structure along the first axis, the first axis being substantially parallel to the incident direction of the first and second light.

25. The reflection module of claim 23, wherein the location of the firstly and secondly reflected light is used to determine an inclination angle of second and third axes of the first and second structures with respect to second and third axes of the reference plate while the first structure stands still with respect to the second structure, the second and third axes being substantially perpendicular to the incident direction of the first and second light.
